(19) United States
(12) Patent Application Publication
(10) Pub. No.: US 2016/0269418 A1
(43) Pub. Date: Sep. 15, 2016

(54) METHOD, SYSTEM, AND APPARATUS FOR MANAGING AND STORING DATA BASED ON INFORMATION SENSITIVITY

(71) Applicants: Nagula Tharma SANGARY, Waterloo (CA); Mahinthan VELUPPILLAI, Kitchener (CA)

(72) Inventors: Nagula Tharma SANGARY, Waterloo (CA); Mahinthan VELUPPILLAI, Kitchener (CA)

(21) Appl. No.: 14/644,597

(22) Filed: Mar. 11, 2015

(51) Int. Cl. H04L 29/06; H04W 12/08; G06F 17/30; H04W 12/06

(52) U.S. Cl. CPC H04L 63/105; H04L 63/08; H04W 12/06; H04W 12/08; G06F 17/30312

(57) ABSTRACT

Methods, systems, and devices for managing and storing sensitive sensor data received at a storage server. The system includes a storage server and a sensor device. The storage server and the sensor devices are implemented using fog computing and fog networking architecture principles. The sensor device has a device identifier and stores sensor data, and is configured to send the device identifier and sensor data to the storage server. The storage server is configured to receive the sensor data, and to determine a sensitivity level of the sensor data. The storage server is further configured to store the sensor data in accordance with the sensitivity level of the sensor data. The sensitivity level indicates anyone of a high sensitivity level and a low sensitivity level.

### TECHNICAL FIELD

Example embodiments relate generally to techniques for data management and storage, and more particularly to storing, securing, and managing sensor data at a storage server.

### BACKGROUND

Sensors continue to play an important role in the modern society. Developments in integrated circuitry and microelectromechanical systems (MEMS) have led to improvements in the miniaturization and battery efficiency of sensors, and have also led to the introduction of new types of sensors to the market. When the modern sensors are combined with developments in wireless systems in modern computing devices, the computing devices are able to conduct complex measurements autonomously and accurately.

The growth of sensors and of computing devices incorporating sensors has resulted in a great amount of data being collected. However, the data collected may be private and sensitive, and it may be advantageous to provide an efficient and secure system to store and manage sensor data.

### BRIEF DESCRIPTION OF THE DRAWINGS

Reference will now be made, by way of example, to the accompanying drawings which show example embodiments, and in which:

FIG. 1 illustrates in block-diagram form an example environment within which example embodiments can be practiced;

FIG. 2 illustrates in block-diagram form a storage server suitable for storing sensor data in accordance with example embodiments;

FIG. 3 illustrates in block-diagram form a sensor device suitable for use in conjunction with the storage server of FIG. 2 and in accordance with example embodiments;

FIG. 4 illustrates a flowchart of a method for managing sensor data received at the storage server of FIG. 2 in accordance with example embodiments; and

FIG. 5 illustrates a flowchart of a method for providing access to sensor data stored at the storage server of FIG. 2 in accordance with example embodiments.

Similar reference numerals may have been use in different figures to denote similar components.

### DETAILED DESCRIPTION OF EXAMPLE EMBODIMENTS

A method for managing sensor data received at a storage server is described. The storage server is configured to autonomously receive and store sensor data from a sensor device (or devices) associated with a user. A sensor device sends sensor data to the storage server, which the storage server receives. The storage server is typically associated with one user, and typically only stores sensor data associated with the one user. The storage server thus typically acts as private server, and may be maintained by the user for the user's own personal use or by a third party (e.g. another user, or a corporation) for exclusive use by the user.

Upon receiving the sensor data, the storage server also determines a sensitivity level of the sensor data. Some sensor devices collect data that is considered sensitive or private in nature, whereas other sensor devices collect data that is not considered sensitive or private in nature. The storage server thus distinguishes between sensor devices based on the sensitivity level of the sensor data the sensor devices collect. The storage server is thus able to selectively secure and encrypt only the sensor data having a high sensitivity level. The storage server stores the sensor data having a low sensitivity in a separate storage compartment without encryption.

The storage server thus acts as a hub for each user's sensor devices. The storage server and the sensor devices are implemented using fog computing and fog networking architecture principles. The storage server is implemented an end-user device in some embodiments, and carries out data storage and management functions on behalf of the sensor devices. Fog computing principles help to improve privacy and security associated with data storage. Furthermore, the sensor devices do not necessarily rely on the Internet to communicate with the storage server for data storage and management.

The storage server balances between the need for security and privacy with the need for efficient data management. The server resources are not wasted securing sensor data having a low sensitivity level. Furthermore, the storage server provides a data storage and management system which can he customized to comply with regulatory and legal requirements of data storage. Since each storage server is typically associated only with one user (and can in some embodiments be configured to store data associated with only one user), compliance with data storage laws and regulations is greatly simplified.

In one particular example, the storage server is configured to receive sensor data from health-monitoring sensor devices, which may include any one of a blood pressure sensor device, a blood glucose sensor device, and a heart-rate sensor device. The storage server will determine the sensitivity level of the health-monitoring sensor data as being of a high sensitivity level, in accordance with an example embodiment.

In one particular example, the storage server is configured to receive sensor data from a home-monitoring system, which may include any one of a carbon monoxide sensor device, a fire sensor device, an LPG gas sensor device, a home-intrusion sensor device, a motion sensor device, a temperature sensor device, and a humidity sensor device. The storage server will determine the sensitivity level of the home-monitoring sensor data as being of a low sensitivity level, in accordance with an example embodiment.

An example embodiment includes a system for managing sensor data. The system includes a storage server and a sensor device. The sensor device has a device identifier and stores sensor data, and is configured to send the device identifier and sensor data to the storage server. The storage server has a processor, an encrypted storage partition, a plaintext storage partition, and a memory coupled to the processor and stores instructions for managing sensor data received at the storage server. The storage server includes a non-transient computer readable medium containing program instructions, which cause the storage server to perform the methods outlined in accordance with the example embodiments described herein. The storage server is configured to receive the sensor data, and to determine a sensitivity level of the sensor data. The storage server is further configured to store the sensor data in accordance with the sensitivity level of the sensor data. The sensitivity level indicates anyone of a high sensitivity level and a low sensitivity level.

Another example embodiment includes a method for managing sensor data received at a storage server. The storage server receives a device identifier and sensor data from a sensor device; determines a sensitivity level of the sensor data, the sensitivity level indicating anyone of a high sensitivity level and a low sensitivity level; and stores the sensor data in accordance with the sensitivity level of the sensor data. To determine the sensitivity level of the sensor data, the processor of the storage server determines a capability of the sensor device; and assigns a sensitivity level to the sensor data in accordance with the capability of the sensor device.

When the sensitivity level of the sensor data is the low sensitivity level, the processor of the storage server optionally stores the sensor data in a plaintext storage partition at the storage server, and when the sensitivity level of the sensor data is the high sensitivity level, the processor of the storage server optionally encrypts the sensor data then stores the data in an encrypted storage partition at the storage server. When the sensitivity level of the sensor data is the low sensitivity level, the processor of the storage server optionally sends the sensor data to a backup server in plaintext, and when the sensitivity level of the sensor data is the high sensitivity level, the processor of the storage server optionally sends the sensor data to a backup server in ciphertext.

The sensor device may include a plurality of sensors. The processor of the storage server determines a sensitivity level of the sensor data of each of the plurality of sensors individually, and stores each the sensor data of each of the plurality of sensors in accordance with the sensitivity level of each of the plurality of sensors.

The processor of the storage server may optionally he configured to receive a data access request from a user device, the access request associated with the sensor data, and in response to the data access request, sends the sensor data in accordance with the sensitivity level of the sensor data. When the sensitivity level of the sensor data is the low sensitivity level, the processor of the storage server sends the sensor data in plaintext to the user device, and when the sensitivity level of the sensor data is the high sensitivity level, the processor of the storage server sends the sensor data in ciphertext to the user device. The data access request may include authentication information. The processor of the storage server may optionally validate the authentication information, and send the sensor data only if the authentication information is valid.

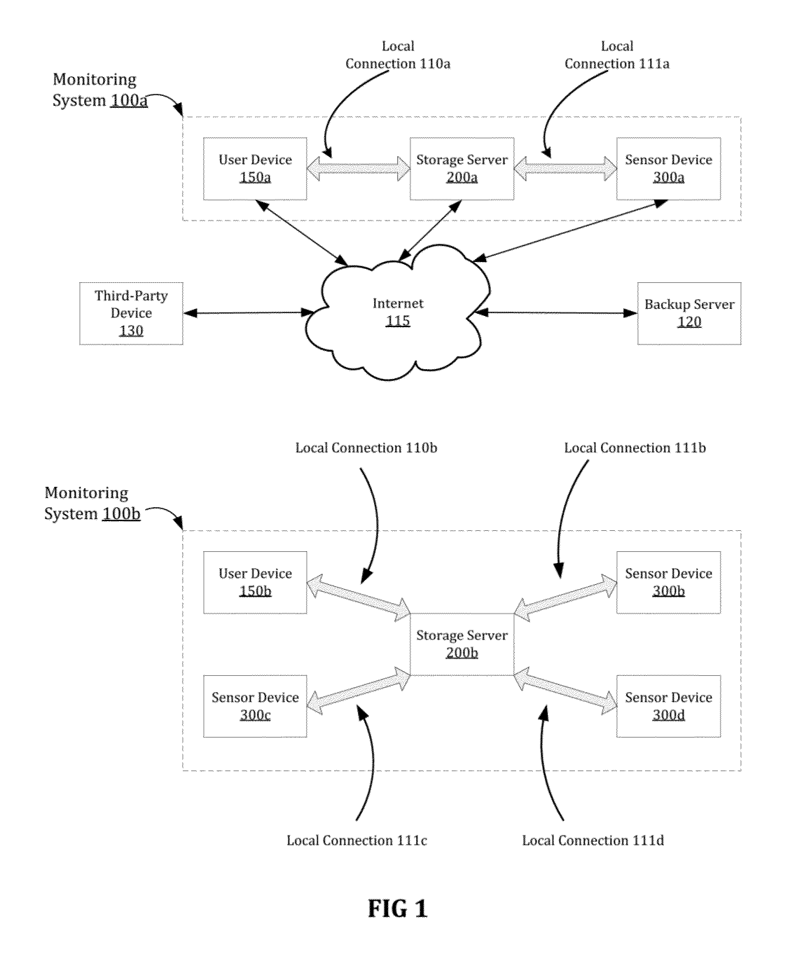

FIG. 1 illustrates one environment within which the techniques of the example embodiments may be practiced. FIG. 1 illustrates two monitoring systems (100a, 100b) configured in accordance with techniques of the example embodiments.

The first monitoring system 100a includes a storage server 200a, a single sensor device 300a, and a user device 150a. Each of the single sensor device 300a and the user device 150a are communicatively coupled to the storage server 200a via the Internet 115. Furthermore, the user device 300a is communicatively coupled to the storage server 200a via a local connection 110a, and the sensor device 300a is communicatively coupled to the storage server 200a via a local connection 111a. Accordingly, the storage server 200a may receive sensor data from the sensor device 300a via the Internet 115 or via the local connection 110a. Similarly, the user device 150a may access sensor data stored on the storage device either via the Internet 115 or via the local connection 110a.

The local connection 110a and 111a may be configured as a wired or wireless personal area network (PAN) in accordance with any known communication protocols, including, without limitations, INSTEON, Wi-Fi™, Wi-Fi Direct™, infrared Data Association (IrDA), wired or wireless USB™, Bluetooth™, Z-Wave™, and ZigBee™. The local connection 110a and 11a may alternatively include a routing device and be configured as a local area network (LAN) or a wireless local area network (WLAN), or may include elements of both a PAN and a LAN.

Also communicatively coupled to the storage server 200a of the monitoring system 100a via the Internet 115 is a backup server 120. The storage server 200a may optionally send sensor data from the sensor device 300a to the backup server 120 for routine and regular backup of the sensor data. The storage server 200a will also send to the backup server 120 user identification information which the backup server 120 will associate with the sensor data 300a. The backup server 300a may maintain a storage partition solely for use by the user. In some embodiments the storage server 200a sends all sensor data to the backup server 120 in ciphertext, and in other embodiments the storage server 200a sends all sensor data to the backup server 120 in plaintext, and in other embodiments a combination of ciphertext and plaintext is used in dependence on the sensitivity level associated with the sensor data.

Examples of the third party device 130 and the user device 150a include, but are not limited to, a mobile phone, smartphone or superphone, tablet computer, notebook computer (also known as a laptop, netbook or ultrabook computer depending on the device capabilities), wireless organizer, personal digital assistant (PDA). The user device 150a and the third party device 130 may execute a specialized application to access the storage server 200a and/or the backup server 120, or may alternatively access a webpage via the Internet 115 which enables access to the sensor data stored on the storage server 200a and/or the backup server 120.

The user device 150a is communicatively coupled to the storage server 200a of the monitoring system 100a via the Internet 115 and via the local connection 110a. The user device 150a may send a request to access data from the storage server 200a. The storage server 200a may request the user device 150a to provide successful authentication to access the server (e.g. by providing any one of a code, a username and password combination, and an access token). The storage server 200a may respond to the user device 150a by either denying the request (e.g. when the authentication is unsuccessful) or by sending the requested data (e.g. when the authentication is successful or not required).

The third-party device 130 is also communicatively coupled to the storage server 200a of the monitoring system 100a via the Internet 115. The third-party device 120 may send a request to access data from the storage server 200a. The storage server 200a may request the third-party device 130 to provide successful authentication to access the server (e.g. by providing any one of a code, a username and password combination, and an access token). The storage server 200a may respond to the third-party device 130 by either denying the request (e.g. when the authentication is unsuccessful) or by sending the requested data (e.g. when the authentication is successful or not required).

Both the user device 150a and third-party device 130 are also communicatively via the Internet 115 to the backup server 120. Either device may send a request to the backup server 120 to access data instead of the storage server 200a.

In one embodiment, the third party device 130 is owned and operated by a healthcare provider, such as any one of a doctor, a hospital, and a health insurance company. In the same embodiment, the monitoring system 100a is configured to collect and store health data associated with a user. When the user visits the healthcare provider, the healthcare provider will benefit from accessing the sensor data to provide better services to the user. The user accordingly authorizes the healthcare provider to access the data stored on the backup server 120 or the storage server 200a using the third party device 130. The third party device 130 sends a request to access the sensor data to either the backup server 120 or the storage server 200a. The backup server 120 or the storage server 200a sends the requested data, thereby enabling the healthcare provider to provide better services to the user.

While the monitoring system 100a only shows a single sensor device 300a, more than one sensor device can be included in any monitoring system. Furthermore, while the monitoring system 100a only shows a single storage server 200a, more than one storage server can be included in any monitoring system. Furthermore, while the monitoring system 100a only shows a single user device 150a, more than one user device can be included in any monitoring system. Furthermore, while the monitoring system 100a only shows a single third-party device 130, more than one third-party device can be included in any monitoring system. Furthermore, while the monitoring system 100a only shows a single backup server 120, more than one backup server can be included in any monitoring system.

The second monitoring system 100b includes a storage server 200b, three sensor devices 300b, 300c, 300d, and a user device 150b. Each of the sensor devices 300b-d is communicatively coupled to the storage server 200b via a local connection 111b-d, and the user device 150b is communicatively coupled to the storage server 200b via a local connection 110b. The storage server 200b, the user device 150b, and the sensor devices 300b-d are substantially similar to the storage server 200a, the user device 150a, and the sensor device 300a, respectively, as described herein.

In this embodiment of the second monitoring system 100b, no device of the monitoring system 100b is communicatively coupled to the Internet 115 for enhanced security. Accordingly, the storage server 200b may receive sensor data from each of the sensor devices 300b-d only the local connections 110b-d established with the sensor device. Similarly, the user device 150b may only access sensor data stored on the storage device via the local connection 110b. The local connection 110b and 111b-d may be configured in substantially the same manner as the local connection 110a and 111a described above.

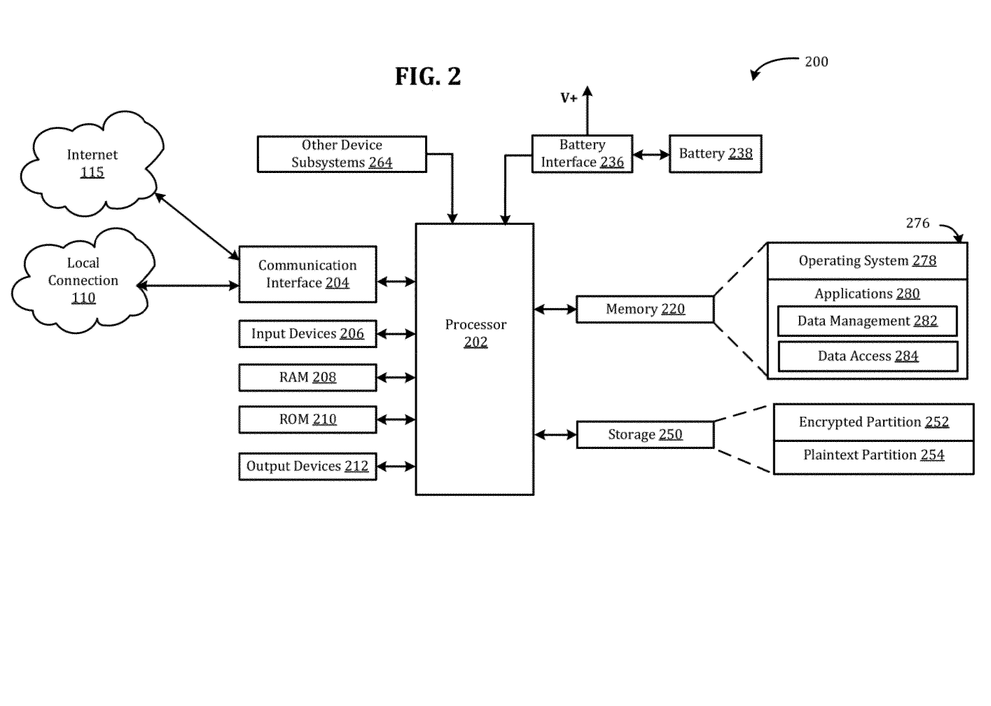

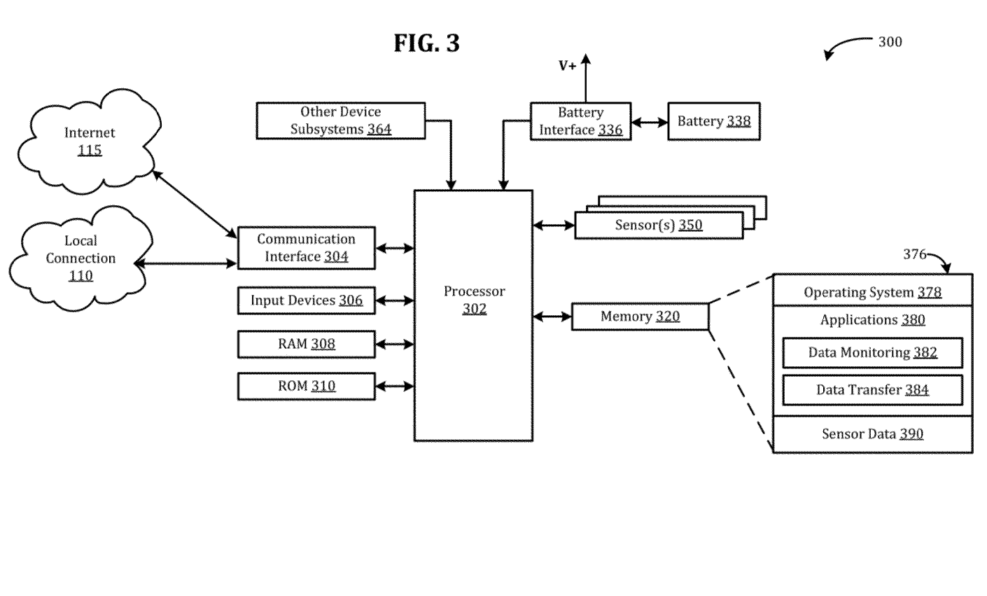

Having illustrated example environments within which the techniques of the example embodiments may be practiced, now more details regarding the storage server 200 and the sensor device 300 will be described. The storage servers 200a and 200b may be implemented substantially in accordance with the description of the storage server 200, as illustrated in FIG. 2. The sensor devices 300a, 300b, 300c, and 300b may be implemented substantially in accordance with the description of the sensor device 300, as illustrated in FIG. 3.

Reference is next made to FIG. 2 which illustrates in block diagram form an example storage server 200 suitable for managing sensor data in accordance with example embodiments. Examples of the storage server 200 include, but are not limited to, a notebook computer (also known as a laptop, netbook or ultrabook computer depending on the device capabilities), a desktop computer, a purpose-built server computer, and a generic server computer.

The storage server 200 includes a rigid case (not shown) housing the electronic components of the storage server 200. The electronic components of the storage server 200 may be mounted on a printed circuit board (not shown) or communicatively coupled thereto by a communications cable. The storage server 200 includes a processor 202 which controls the overall operation of the storage server 200. Communication functions are performed through a communication interface 204. The communication interface 204 receives data and messages from and sends data and messages via either the Internet 115 or the local connection 110. The communication interface 204 typically includes an Ethernet interface for communication over wired networks, and a WLAN interface for communication over Wi-Fi™ networks.

The processor 202 interacts with other components including one or more input devices 206 (such as a pushbutton, a keyboard, and/or touch-sensitive display), one or more output devices 212 (such as an LED, and/or a display), RAM 208, ROM 210, persistent (non-volatile) memory 220, auxiliary I/O subsystems (not shown), one or more data port (not shown) such as serial data port (e.g., USB data port), storage 250 (including an encrypted storage partition 252 and a plaintext storage partition 254), and other device subsystems generally designated as 264. The components of the storage server 200 are coupled via a communications bus (not shown) which provides a communication path between the various components.

The processor 202 operates under stored program control and executes software modules 276 stored in memory, for example, in the storage 250. The storage 250 stores data such as user data, sensor data, and information regarding the components and technical capabilities of sensor devices (such as sensor devices 300a-d of FIG. 1). As illustrated in FIG. 2, the software modules 276 comprise operating system software 278 and software applications 280. The software applications 280 may include a data management application 282 and a data access application 284. The software modules 276 or parts thereof may be temporarily loaded into volatile memory such as the RAM 208. The RAM 208 is used for storing runtime data variables and other types of data or information. Although specific functions are described for various types of memory, this is merely one example, and a different assignment of functions to types of memory could be used.

The input devices 206 may include a keyboard, control buttons (not shown) such as a power toggle (on/off) button, volume buttons, general purpose or context specific buttons, ‘back’ or ‘home’ buttons, and/or a navigation device. When a display screen is provided as part of a touchscreen, the various buttons or controls may be provided by onscreen user interface elements displayed on the display screen instead of, or in addition to, physical interface components. The keyboard may be provided instead of, or in addition to, a touchscreen depending on the embodiment. At least some of the control buttons may be multi-purpose buttons rather than special purpose or dedicated buttons.

The output devices 212 may include an LED indicator, a touch-sensitive display, a dot-matrix display or other type of display. The output devices 212 are operably coupled to an electronic controller (not shown) and to the processor 202. User-interaction with a GUI (graphical user interface) is performed through the input devices 206. Information, such as LED light patterns, text, characters, symbols, images, icons, and other items are rendered and displayed on the output devices 212 via the processor 202.

The storage server 200 may optionally include a battery 238 as a power source, which is typically one or more rechargeable batteries that may be charged, for example, through charging circuitry coupled to a battery interface such as a serial data port (not shown). The battery 338 provides electrical power to at least some of the electrical circuitry in the sensor device 200, and the battery interface 236 provides a mechanical and electrical connection for the battery 238. The battery interface 236 is coupled to a regulator (not shown) which provides power V+ to the circuitry of the sensor device 200.

The communication interface 204 may include a short-range wireless communication subsystem (not shown) which provides a short-range wireless communication interface. The wireless communication interface may be configured in accordance with one or more cellular telecommunication standards, including any of a Bluetooth™ standard, an IEEE 802.11 standard (also referred to as Wi-Fi™), an IEEE 802.15.3a standard (also referred to as UWB), a Z-Wave standard, a ZigBee™ standard or other suitable short-range wireless communication standard. A received signal, such as a message or sensor data, is processed by the communication subsystem 204 and input to the processor 202. The processor 202 processes the received signal in accordance with the data management application 282, the data access application 284, or any other application in the memory 220.

The storage 250 includes at least one computer readable medium for storing data and applications, and is typically a hard-disk drive, but may be implemented using any other suitable storage medium such as, without any limitations, a solid-state drive, an optical storage device, and a magnetic tape. The storage 250 is typically formatted according to a file system format, and data is typically organized into files and directories. The storage 250 may include one or more storage mediums. However, if a single storage medium, such a single hard-disk drive, the hard-disk drive is formatted into two or more storage partitions, including an encrypted partition 252 and a plaintext partition 254. The encrypted partition stores encrypted data; therefore, the processor 202 typically encrypts data in accordance with a data encryption algorithm and key before storing data in the encrypted partition 252. The encryption algorithm may however be implemented on a hardware module coupled to the processor 202. The plaintext partition stores data in plaintext, and no encryption is required. If more than one hard-disk drive is available, one drive may be configured solely for either encrypted or plaintext data storage. The data management application 282 determines which partition to use to store different sensor data.

Reference is next made to FIG. 3 which illustrates in block diagram form an example sensor device 300 suitable for sending sensor data to the storage server 200 in accordance with example embodiments.

The sensor device 300 includes a rigid case (not shown) housing the electronic components of the sensor device 300. The electronic components of the sensor device 300 may be mounted on a printed circuit board (not shown) or communicatively coupled thereto by a communications cable. The sensor device 300 includes a processor 302 which controls the overall operation of the sensor device 300. Communication functions are performed through a communication interface 304. The communication interface 304 receives data and messages from and sends data and messages via either the Internet 115 or the local connection 110. The communication interface 304 typically includes a WLAN interface for communication over networks.

The processor 302 interacts with other components including one or more input devices 306 such as a keyboard and/or touchscreen, RAM 308, ROM 310, persistent (non-volatile) memory 320, auxiliary I/O subsystems (not shown), one or more data port (not shown) such as serial data port (e.g., USB data port), sensors 350, and other device subsystems generally designated as 364. The components of the sensor device 300 are coupled via a communications bus (not shown) which provides a communication path between the various components.

The processor 302 operates under stored program control and executes software modules 376 stored in memory. As illustrated in FIG. 3, the software modules 376 comprise operating system software 378, software applications 380, and sensor data 390. The software applications 380 may include a data monitoring application 382 and a data transfer application 384. The software modules 376 or parts thereof may be temporarily loaded into volatile memory such as the RAM 308. The RAM 308 is used for storing runtime sensor data and other types of data or information. Although specific functions are described for various types of memory, this is merely one example, and a different assignment of functions to types of memory could be used. The ROM 310 is used to run-time instructions, and may include a device identification number (e.g. a serial number).

The sensor device includes at least one sensor 350. The data monitoring application 382 manages the operation of the sensor or sensors 350 of the sensor device 300. Each sensor 350 is typically coupled to a sensor cache (not shown), which stores sensor data momentarily. The processor 302, under instruction of the data monitoring application 382, typically sets the sampling rate and the sensitivity level of the sensor, and retrieves sensor data generated by the sensor or sensor 350 from the sensor cache (not shown). The processor 302 typically sends the data generated to the RAM 308, which acts as a buffer before storage of the sensor data 390 in the memory 320. Examples of sensors 350 include, but are not limited to, accelerometers, barometers, flow sensors, carbon monoxide sensors, smoke sensors, heat sensors, thermometers, blood glucose sensors, cholesterol sensors, magnetometers, oxygen sensors, and pH sensors.

The data transfer application 384 manages the interaction of the sensor device 300 with the storage server 200. The data transfer application 384 sets intervals for sending the sensor data 390 to the storage server. Furthermore, the data transfer application 384 may cause the processor 302 to send the sensor data 390 to the storage server 200 via the communication interface 304. After sending the sensor data 390, the application may optionally delete the data from the memory 320 of the sensor device 200; thereby ensuring that the sensor device 200 does not run out of memory.

The input devices 306 may include a keyboard, control buttons (not shown) such as a power toggle (on/off) button, volume buttons, general purpose or context specific buttons, ‘back’ or ‘home’ buttons, and/or a navigation device. When a display screen is provided as part of a touchscreen, the various buttons or controls may be provided by onscreen user interface elements displayed on the display screen instead of, or in addition to, physical interface components. The keyboard may be provided instead of, or in addition to, a touchscreen depending on the embodiment. At least some of the control buttons may be multi-purpose buttons rather special purpose or dedicated buttons.

The communication interface 304 may include a short-range wireless communication subsystem (not shown) which provides a short-range wireless communication interface. The wireless communication interface may be configured in accordance with one or more cellular telecommunication standards, including any of a Bluetooth™ standard, an IEEE 802.11 standard (also referred to as Wi-Fi™), an IEEE 802.1.5.3a standard (also referred to as UWB), a Z-Wave standard, a ZigBee™ standard or other suitable short-range wireless communication standard.

The sensor device 300 may optionally include a battery 338 as a power source, which is typically one or more rechargeable batteries that may be charged, for example, through charging circuitry coupled to a battery interface such as a serial data port (not shown). The battery 338 provides electrical power to at least some of the electrical circuitry in the sensor device 300, and the battery interface 336 provides a mechanical and electrical connection for the battery 338. The battery interface 336 is coupled to a regulator (not shown which provides power V+ to the circuitry of the sensor device 300.

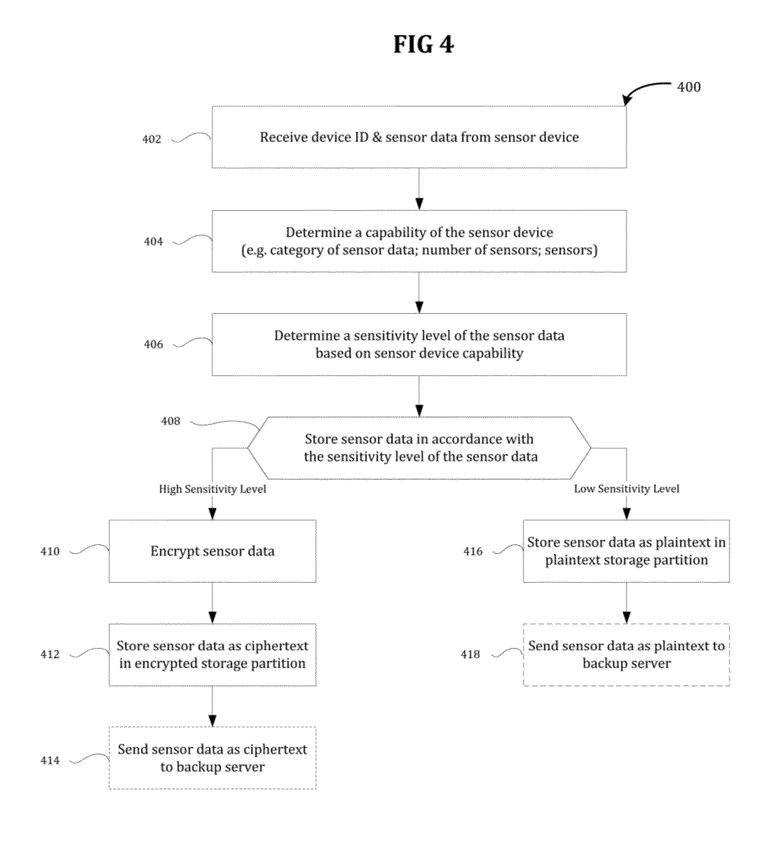

Reference is now made to FIG. 4 which illustrates a flowchart of a method 400 for managing sensor data received at the storage server 200. The method 400 may be implemented by the storage server 200 or other server device. The method 400 may be carried out by software executed, for example, by a processor. Coding of software for carrying out such a method 400 is within the scope of a person of ordinary skill in the art. The method 400 may contain additional or fewer processes than shown and/or described, and may be performed in a different order. Computer-readable code executable by the processor 202 to perform the method 400 may be stored in a computer-readable medium such as a memory of a storage server.

The data monitoring application 382 of the sensor device 300 instructs the processor 302 to enable the sensor 350. Accordingly, the sensor 350 begins to collect sensor data 390. After initiating the data collection, the data transfer application 384 of the sensor device 300 establishes a connection with the storage server 200, either via the Internet 115 or via the local connection 110. The storage server 200 and the sensor device 300 may exchange messages establishing a handshaking protocol prior to data transmission. The sensor device 300 sends, through the communication interface 304 of the sensor device 300, to the storage server 200 a device identification associated with the sensor device 300.

At 402, the storage server 200 receives, either via the Internet 115 or via the local connection 110, through the communication interface 204 of the storage server 200, the device identification associated with the sensor device 300 and sensor data from the sensor device 300. The device identifier of the sensor device 300 may uniquely identify the particular sensor device 300, or may only identify the make and model of the sensor device.

At 404, the processor 202 of the storage server 200 determines the capability of the sensor device 300. The capability of the sensor device may depend on several factors, including, but not limited to, the category of sensor data, number of sensors, and types of sensors 350 activated in the sensor device 300. The processor 202 relies on the device identifier to determine the capability of the sensor device. The processor 202 may first query a database stored in local memory 220 of the storage server 200 to determine if the device identifier matches a device in the database. The device identifier may match a device in the database if the sensor device 300 was previously connected to the storage server 200. The database may thus include information regarding the capability of the sensor device 300. However, if the query fails (i.e. the device identifier is not present in the local database), the processor 202 may query an online database, via the Internet 115, to determine the device capability. Finally, if the online query fails, or if no Internet connection is available, the processor 202 may request the sensor device 300 to provide additional identification information.

At 406, the processor 202 of the storage server 200 determines a sensitivity level of the sensor data from the sensor device 300. The sensitivity level may indicate anyone of a high sensitivity level and a low sensitivity level. Sensor data that is of a private and sensitive nature has a high sensitivity level, whereas sensor data is that is of a non-private and non-sensitive nature has a low sensitivity level.

At 406, the processor 202 determines and assigns the sensitivity level of the sensor data based on the sensor device capability, as determined at 404. The local memory 220 of the storage server 200 may include a list of sensor device capabilities associated with sensor data of a high sensitivity. If the sensor device capability includes any one of the capabilities associated with sensor data of a high sensitivity, then the processor 202 determines that the data is of a high sensitivity level. For example, health data or location data may be categorized as data of a high sensitivity level, whereas activity tracking or room temperature data may be categorized as data of a low sensitivity level.

At 406, if the sensor device capability, as determined at 404, indicates that the sensor device 300 includes multiple sensors 350, then the processor 202 determines the sensitivity level of each sensor's data is determined individually. For example, an activity tracker may include an accelerometer sensor and a location sensor (e.g. global positioning system (GPS) data). The accelerometer data is not considered private, whereas the location data is considered private. Accordingly, at 406 the processor 202 will determine that the location data is of a high sensitivity level, and the accelerometer data is a of a low sensitivity level.

At 408, the processor 202 stores the sensor data in accordance with the sensitivity level of the sensor data. Sensor data of a high sensitivity level is stored in a more secure manner than sensor data of a low sensitivity level. In some embodiments the sensor data is encrypted only if it is of a high sensitivity level. This is advantageous, as encryption and decryption algorithms are time-consuming processor-intensive tasks. Accordingly, the method 400 permits the storage server 200 to apply its processing resources to the most important tasks.

When the sensor data is of a high sensitivity level, the processor 202 is configured to encrypt the sensor data using a data encryption algorithm and an encryption key at 410. In some embodiments, a hardware encryption module is included in the storage server 200 and coupled to the processor 202. Accordingly, the sensor data is encrypted using the hardware encryption module if a suitable module is available. The processor 202 then stores the encrypted sensor data ciphertext in the encrypted storage partition 252 of the storage server 200 at 412.

In some embodiments, the processor 202 will send the encrypted ciphertext through the communication interface 204 and via the Internet 115 to the backup sever 120 for backup at 414. The processor 202 also sends data identifying the storage server 200 and the user associated with the storage server 200 to permit the storage server 200 and the user to access the data as needed.

When the sensor data is of a low sensitivity level, the processor 202 is configured to store the sensor data in plaintext in the plaintext storage partition 254 of the storage server 200 at 416. In some embodiments, the processor 202 is configured to send the sensor data in plaintext through the communication interface 204 and via the Internet 115 to the backup sever 120 for backup at 418. The processor 202 also sends data identifying the storage server 200 and the user associated with the storage server 200 to permit the storage server 200 and the user to access the data as needed.

Furthermore, in some embodiments, the processor 202 may categorize the sensor data into different categories based on the sensor device capability, as determined at 404, and later apply different storage rules to each category. For example, the categories may include any one of a home-monitoring category, a health-monitoring category, an activity tracking category, a weather-monitoring category, and a vehicle tracking category. The processor 202 may then store the sensor data in a storage partition associated with the category of the sensor data, if the sensor data is of a high sensitivity level, the processor 202 may store the sensor data in an encrypted storage partition associated with the category of the sensor data, and if the sensor data is of a low sensitivity level, the processor 202 may store the sensor data in a plaintext storage partition associated with the category of the sensor data. In some embodiments, the processor may define more than two sensitivity levels. Each sensitivity level may be assigned a code name and has security settings associated therewith. In one example, the processor categorizes sensor data into one of multiple categories, for example, five categories; level 1, level 2, level 3, level 4, and level 5. Associated with each level is a different set of security settings; for example, data associated with level 1 is encrypted using 264-hit encryption., data associated with level 2 is encrypted using 128-hit encryption, data associated with level 3 is encrypted using 64-bit encryption, data associated with level 4 is not encrypted but is only stored locally on the storage server 200, and data associated with level 5 is not encrypted, is stored on the storage server 200, and is sent to the backup server 120. Furthermore, each category of sensor type may be associated with a particular security level (e.g. Level 1 to level 5), and all sensor data from with each category is stored in accordance with the security settings associated with the security level, as explained.

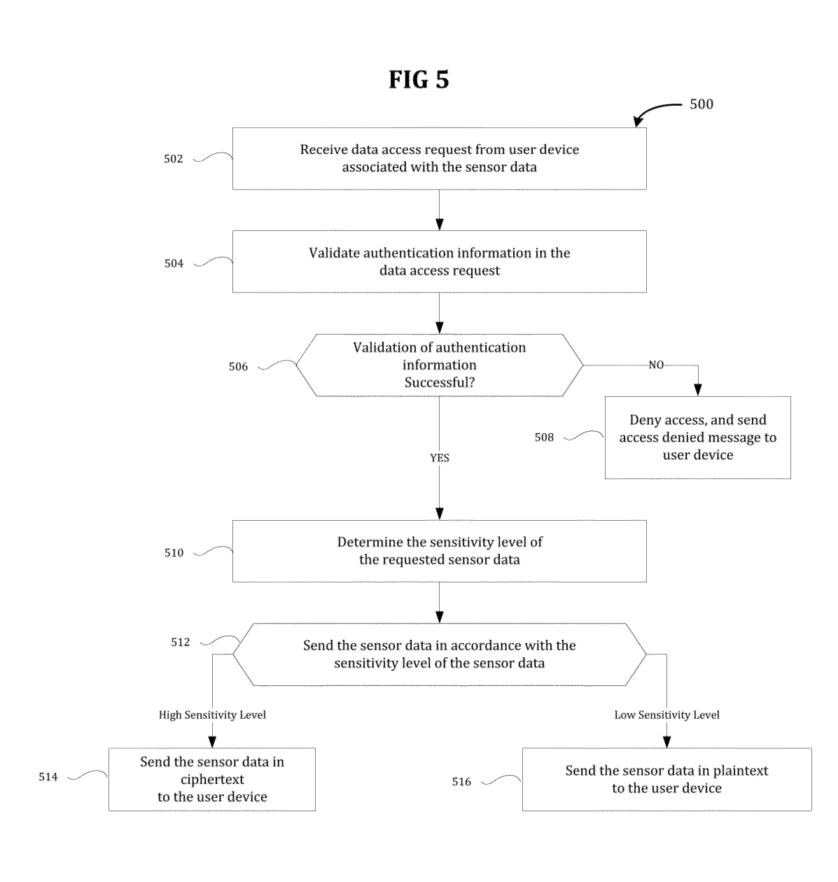

Reference is now made to FIG. 5 which illustrates a flowchart of a method 500 for accessing sensor data stored at the storage server 200. The method 500 may be implemented by the storage server 200 or other server device. The method 500 may be carried out by software executed, for example, by a processor. Coding of software for carrying out such a method 500 is within the scope of a person of ordinary skill in the art. The method 500 may contain additional or fewer processes than shown and/or described, and may be performed in a different order. Computer-readable code executable by the processor 202 to perform the method 500 may be stored in a computer-readable medium such as a memory of a storage server.

The user device 150 or the third party device 130 may initiate the method 500 by sending to the storage server 200a a request to access sensor data. The request may include authentication information to access the sensor data, and information identifying the data being accessed. The request is sent via the Internet 115 or the local connection 110, and is received at the communication interface 204 of the storage server 200 at 502. The processor 202 then handles the request.

At 504 the processor 202 validates the authentication information, and will only send data in response to the request if the validation of the authentication information is successful. At 506 the processor 202 determines if the validation of the authentication information was successful. If the validation was unsuccessful, at 508 the processor sends an access denied message to the user device 150 or the third party device 130 through the communication interface 204 of the storage server 200 and via the Internet 115 or the local connection 110.

Only if the validation was successful, the method 500 proceeds to 510. The processor 202 will send the requested sensor data in accordance with the sensitivity level of the sensor data. Accordingly, at 510, the processor 202 determines the sensitivity level of the requested sensor data. In some embodiments, if the data access request is received via the Internet 115, then the processor 202 determines the sensitivity level of the requested sensor data to be the high sensitivity level, regardless of the contents of the sensor data. This is in recognition of the dangers of sending data across the Internet 115, where data security breaches are frequent. In some embodiments, if the data access request is received via the local connection 110, then the processor 202 determines the sensitivity level of the requested sensor data to be the low sensitivity level, regardless of the contents of the sensor data. In other embodiments, the processor 202 determines the sensitivity level of the requested sensor data based on the device capability information as determined at step 404.

At 512, the processor 202 sends the sensor data in accordance with the sensitivity level of the sensor data. If the sensor data is of a high sensitivity level, as determined at 510, then the processor 202 sends the sensor data in ciphertext to the user device or the third party device. If the sensor data is not already encrypted on the storage server 200, then the processor 202 encrypts the sensor data into ciphertext prior to sending the data. If the sensor data is of a low sensitivity level, as determined at 510, then the processor 202 sends the sensor data in plaintext to the user device or the third party device. If the sensor data is not already in plaintext on the storage server 200, then the processor 202 decrypts the sensor data into plaintext prior to sending the data.

Accordingly, the storage server 200 is capable of receiving and storing sensor data, and identifying the sensitivity of the sensor data. When the data is sensitive, the storage server implements encryption and security features to protect the data. When the data is non-sensitive, the storage server implements minimal security features to ensure efficiency of the system. The storage server 200 provides access to the data via user devices over the Internet or over a local network.

The above-described embodiments are intended to be examples only. Those of skill in the art may affect alterations, modifications, and variations to the particular embodiments without departing from the scope of the application. The teachings of the present disclosure are intended to cover and embrace all suitable changes in technology.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. Moreover, the present disclosure is also directed to a pre-recorded storage device or other similar computer readable medium including program instructions stored thereon for performing the methods described herein.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A method for managing sensor data received at a storage server, the method comprising:
receiving, at the storage server, a device identifier and sensor data from a sensor device;
determining a sensitivity level of the sensor data, the sensitivity level indicating anyone of a high sensitivity level and a low sensitivity level; and
storing the sensor data in accordance with the sensitivity level of the sensor data.

2. The method of claim 1, wherein determining the sensitivity level of the sensor data comprises;
determining a capability of the sensor device; and
assigning a sensitivity level to the sensor data in accordance with the capability of the sensor device.

3. The method of claim 2, wherein storing the sensor data in accordance with the sensitivity level of the sensor data comprises:
when the sensitivity level of the sensor data is the low sensitivity level, storing the sensor data in a plaintext storage partition at the storage server, and
when the sensitivity level of the sensor data is the high sensitivity level, encrypting the sensor data then storing the data in an encrypted storage partition at the storage server.

4. The method of claim 3, wherein storing the sensor data in accordance with the sensitivity level of the sensor data comprises:
when the sensitivity level of the sensor data is the low sensitivity level, sending the sensor data to a backup server in plaintext, and
when the sensitivity level of the sensor data is the high sensitivity level, sending the sensor data to a backup server in ciphertext.

5. The method of claim 4, further comprising:
receiving, at the storage server, a data access request from a user device, the access request associated with the sensor data; and
sending the sensor data in accordance with the sensitivity level of the sensor data.

6. The method of claim 5, wherein sending the sensor data in accordance with the sensitivity level of the sensor data comprises:
when the sensitivity level of the sensor data is the low sensitivity level, sending the sensor data in plaintext to the user device, and
when the sensitivity level of the sensor data is the high sensitivity level, sending the sensor data in ciphertext to the user device.

7. The method of claim 6, wherein the data access request includes authentication information, and the method further comprising validating the authentication information, and sending the sensor data only if the authentication information is valid.

8. The method of claim 1, wherein the sensor device includes a plurality of sensors, the method further comprising determining a sensitivity level of the sensor data of each of the plurality of sensors individually.

9. The method of claim 8, further comprising storing each the sensor data of each of the plurality of sensors in accordance with the sensitivity level of each of the plurality of sensors.

10. The method of claim 1, wherein determining a sensitivity level of the sensor data further comprises categorizing the sensor data into one of a plurality of categories.

11. A storage server comprising
a processor;
an encrypted storage partition;
a plaintext storage partition;
a memory coupled to the processor and storing instructions for managing sensor data received at the storage server, wherein the processor is configured to:
receive a device identifier and sensor data from a sensor device;
determine a sensitivity level of the sensor data, the sensitivity level indicating anyone of a high sensitivity level and a low sensitivity level; and
store the sensor data in accordance with the sensitivity level of the sensor data in anyone of the encrypted storage partition and the plaintext storage partition.

12. The storage server of claim 11, wherein the processor is further configured to:
determine a capability of the sensor device; and
assign a sensitivity level to the sensor data in accordance with capability of the sensor device.

13. The storage server of claim 12, wherein the processor is further configured to:
when the sensitivity level of the sensor data is the low sensitivity level, store the sensor data in a plaintext storage partition at the storage server, and
when the sensitivity level of the sensor data is the high sensitivity level, encrypt the sensor data then store the data in an encrypted storage partition at the storage server.

14. The storage server of claim 13, wherein the processor is further configured to:
when the sensitivity level of the sensor data is the low sensitivity level, send the sensor data to a backup server in plaintext, and
when the sensitivity level of the sensor data is the high sensitivity level, send the sensor data to a backup server in ciphertext.

15. The storage server of claim 14, wherein the processor is further configured to:
receive, at the storage server, a data access request from a user device, the access request associated with the sensor data; and
send the sensor data in accordance with the sensitivity level of the sensor data.

16. The storage server of claim 5, wherein the processor is further configured to:
when the sensitivity level of the sensor data is the low sensitivity level, send the sensor data in plaintext to the user device, and
when the sensitivity level of the sensor data is the high sensitivity level, send the sensor data in ciphertext to the user device.

17. The storage server of claim 16, wherein the data access request includes authentication information, and wherein the processor is further configured to validate the authentication information, and send the sensor data only if the authentication information is valid.

18. The storage server of claim 11, wherein the sensor device includes a plurality of sensors, and wherein the processor is further configured to determine a sensitivity level of the sensor data of each of the plurality of sensors individually.

19. The storage server of claim 18, wherein the processor is further configured to store each the sensor data of each of the plurality of sensors in accordance with the sensitivity level of each of the plurality of sensors.

20. A system for managing sensor data, the system comprising;
a storage server, the storage server comprising an encrypted storage partition and a plaintext storage partition;
a sensor device having a device identifier and storing sensor data, and configured to send the device identifier and sensor data to the storage server;
wherein the storage server is configured to receive the sensor data, and to determine a sensitivity level of the sensor data, the sensitivity level indicating anyone of a high sensitivity level and a low sensitivity level; and
wherein the storage server is further configured to store the sensor data in accordance with the sensitivity level of the sensor data.
